(19) United States
(12) Patent Application Publication
(10) Pub. No.: US 2004/0253741 A1
(43) Pub. Date: Dec. 16, 2004

(54) Analyte detection in liquids with carbon nanotube field effect transistor devices

(76) Inventors: Alexander Star, Albany, CA (US); George Gruner, Los Angeles, CA (US)

Correspondence Address: Brian M. Berliner, O'MELVENY & MYERS LLP, 400 South Hope Street, Los Angeles, CA, 90071-2899, US

(21) Appl. No.: 10/773,631

(22) Filed: Feb. 6, 2004

Related U.S. Application Data
(60) Provisional application No. 60/445,654, filed on Feb. 6, 2003.

(51) Int. Cl. G01N 27/12

(52) U.S. Cl. 436/150; 422/98; 422/82.02

(57) ABSTRACT

Field-effect transistor (FET) devices with carbon nanotubes as the conducting channel detect chemicals in liquids are described. Chemical detection occurs primarily through analysis of conduction (l) as a function of the applied gate voltage (Vg). The conductivity of liquids is an important variable in the analysis of measurements of the device performance. In high-conducting liquids, screening and liquid conductance dominate in the device measurements; in low-conductive liquids (e.g., cyclohexane), the changes in the NTFET device performance upon exposure to different chemicals are similar to those found for the performance of the device in a gaseous environment. The influence of aromatic compounds on the device electronics can be correlated with their relative ability to donate or withdraw electrons from the carbon nanotube. A shift in the threshold of l-Vg was found to be linear with Hammett sigma values (σₚ) for mono-substituted benzene compounds.

### CROSS-REFERENCE TO RELATED APPLICATION

This application claims priority pursuant to 35 U.S.C. § 119(e) to U.S. Provisional Application Ser. No. 60/445,654, filed Feb. 6, 2003, which application is specifically incorporated herein, in its entirety, by reference.

### BACKGROUND OF THE INVENTION

1. Field of the Invention

The present invention relates to nanotube sensors, and in particular to the utilization of these sensors in the detection of analytes in a liquid environment.

2. Description of Related Art

A variety of spectroscopic methods are currently used to detect analytes and monitor chemical reactions in a liquid environment. These detection methods, where electronic signal generation in response to an analyte is mediated by an optical step, are sensitive to changes in electronic configurations of the atoms and molecules involved in such reactions. Electronic detection devices with transistor configurations have also been fabricated and used for direct electronic signal generation in response to an analyte, although such techniques however have not yielded fully satisfactory alternatives to spectroscopic detection.

The recent emergence of nano-scale devices offers the opportunity to effect extremely sensitive electronic detection of analytes by monitoring the electronic performance of such devices as they are exposed to a test sample environment. Field-effect transistors (FETs) fabricated using semiconducting single wall carbon nanotubes (nanotube FETs, NTFETs) and their electrical performance characteristics have been studied extensively. The conductance characteristics of carbon nanotubes have been found, for example, to be sensitive to the presence of various gases, such as oxygen and ammonia, and thus nanotubes included in an electrical circuit can operate as sensitive chemical sensors. NTFET devices, as well as nanowire-based devices, are promising candidates for the electronic detection of biological species. The mechanism of the electrical responsiveness of these devices to the presence of analytes occurs through transfer of charge between the analyte and the nanotube conducting channel, as evidenced by experiments involving electron donating (NH3) and electron withdrawing (NO2) molecules in gas phase. Such nanotube-based devices have also been configured in such a way that the gate electrode is provided by a buffer, in this configuration these devices can be used as pH sensors.

### SUMMARY OF THE INVENTION

Field-effect transistor (FET) devices with carbon nanotubes as the conducting channel are shown to detect chemicals in liquids. Chemical detection occurs primarily through analysis of conduction (l) as a function of the applied gate voltage (V_{g}). The conductivity of liquids is an important variable in the analysis of measurements of the device performance. In conducting liquids, screening and liquid conductance dominate in the device measurements; in non-conductive liquids (e.g., cyclohexane), the changes in the NTFET device performance upon exposure to different chemicals are similar to those found for the performance of the device in a gaseous environment. The influence of aromatic compounds on the device electronics can be correlated with their relative ability to donate or withdraw electrons from the carbon nanotube. A shift in the threshold of l-V_{g} was found to be linear with Hammett sigma values (σₚ) for monosubstituted benzene compounds.

A more complete understanding of the invention will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

FIG. 1 schematically depicts a carbon nanotube field-effect transistor (NTFET), showing a NT transducer contacted by two Ti/Au electrodes (source and drain) with a silicon back gate.

FIG. 2 is an atomic force microscope topograph (the microscope being operated in a tapping mode) of an exemplary nanotube device.

FIGS. 3A-C show comparisons of the performance characteristics of an NTFET device as it operates in air or in the presence of a solvent (water, 2-propanol, or cyclohexane). The conductance—gate voltage relationship (l_{sd}-V_{g}) is shown in plots of conductance (μS) as a function of gate voltage (V). In FIG. 3A, the performance in water and air are compared. In FIG. 3B, the performance in 2-propanol and air are compared. In FIG. 3C, the performance in cyclohexane and air are compared.

FIGS. 4A-B show comparisons of the l_{sd}-V_{g} performance characteristics of an NTFET device as it operates in cyclohexane, a 1M solution of aniline in cyclohexane, and a 0.1 m solution of aniline in cyclohexane. FIG. 4A directly compares performance in cyclohexane in the absence and presence of 1M aniline. FIG. 4B directly compares performance in cyclohexane in the absence and presence of 0.1M aniline.

FIGS. 5A-B show comparisons of the l_{sd}-V_{g} performance characteristics of an NTFET device as it operates in cyclohexane, a 1 M solution of chlorobenzene in cyclohexane, and a 1 M solution of nitrobenzene in cyclohexane. FIG. 5A directly compares performance in cyclohexane in the absence and presence of 1M chlorobenzene. FIG. 5B directly compares performance in cyclohexane in the absence and presence of 1M nitrobenzene.

FIG. 6 is a schematic depiction of a single walled carbon nanotube conducting channel with monosubstituted benzene molecule adsorbed on side-wall of nanotube in cyclohexane solution.

FIG. 7 is a schematic depiction of the l_{sd}-V_{g} performance characteristics of an NTFET device as it operates in a standard solvent in the absence and presence of an analyte, drawing attention to the graphic representation of the ΔV_{g} and δV_{g} terms.

FIG. 8 is a plot of gate voltage shift of the typical NTFET for each aromatic compound at 0.1M concentration in cyclohexane as a function of the Hammett sigma values (σₚ) for monosubstituted benzene compounds.

FIG. 9 shows the dependence of the gate voltage shift (ΔV_{g}) with changing hysteresis (δV_{g}).

### DETAILED DESCRIPTION OF THE PREFERRED EMBODIMENT

The present disclosure provides an electronic device that include nanotubes in the conducting channel as chemical sensors in non-conducting or low-conducting liquid environments. In a non- or low-conducting solvent, charge transfer reactions between the analyte and the device dominate the device response, and the response is characterized by an increase and a shift in the hysteresis of the dependence of the source-drain current on the gate voltage (the l_{sd}-V_{g} relationship). Furthermore, a clear correlation between the change of the device characteristics and electronic properties of the liquid environment is observed.

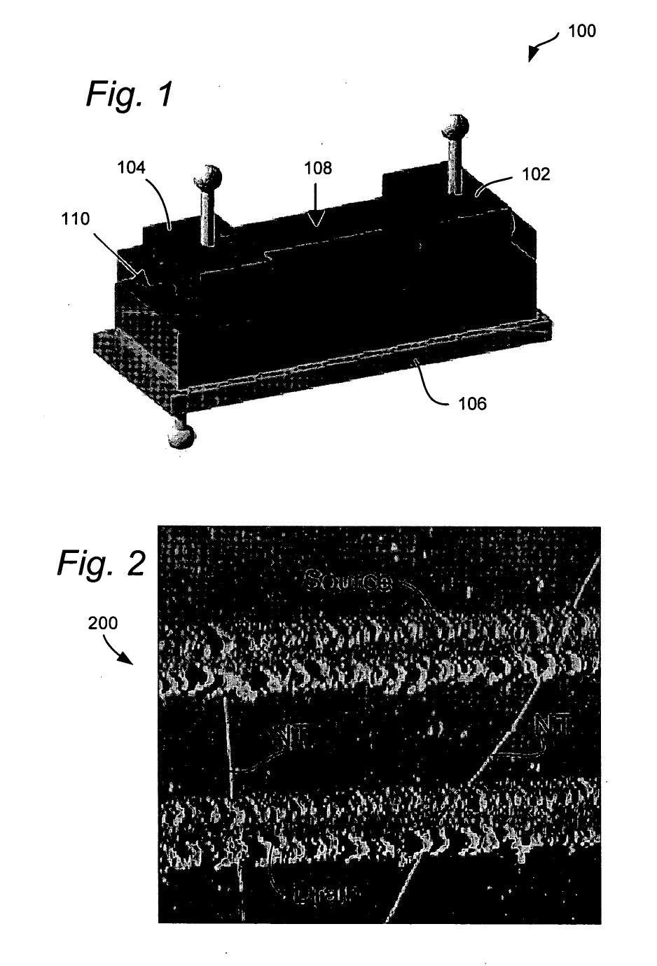

FIG. 1 schematically depicts the layout of the device 100 architecture. Single wall nanotubes (SWNTs) 110 electrically coupled to titanium contacts 102, 104, together with the silicon back gate 106, form the elements of the NTFET architecture. As described herein, nanotube 110 may be immersed in a liquid 108 for sensing of dissolved analytes. NTFETs were fabricated using nanotubes grown by chemical vapor deposition. Iron nanoparticles encased in mesoporous material were spin-coated and patterned on silicon substrates with 200 nm films of thermal SiO₂. Nanotubes of 1.5-3.0 nm diameter and 5-10 μm length were grown over the course of 15 minutes of methane flow at 900° C. Hydrogen was added to the gas stream to prevent the deposition of amorphous carbon contaminants. For the devices fabricated, multiple nanotubes connect the source and drain electrodes, with electrical characteristics of individual tubes varying from metallic to semiconducting. FIG. 2 shows an atomic force microscopic image of the device 200 with a number of nanotubes crossing the source and drain electrodes.

The performance of devices such as these was determined by monitoring the change in the source-drain current l_{sd} as a function of the gate voltage (V_{g}) while both increasing and decreasing gate voltages; in order to delineate the full l_{sd}(V_{g}) characteristic. While in devices incorporating a multitude of nanotubes, both metallic and semiconducting nanotubes contribute to the source-drain current, data presented here are derived from devices with only semiconducting nanotubes, for which an off-state (positive V_{g} values) the conductivity is close to zero. Device testing procedures were as follows. For measurements in air, pin probes were simply exposed to air. For measurements in conducting liquids, the silicon chips with NTFET devices were glued to aluminum plates and surrounded with epoxy walls to keep the solution on the chip without contacting the gate (to prevent the shorting of the source-drain current to the gate). A glass pipette was used to position a drop of test liquid on the chip.

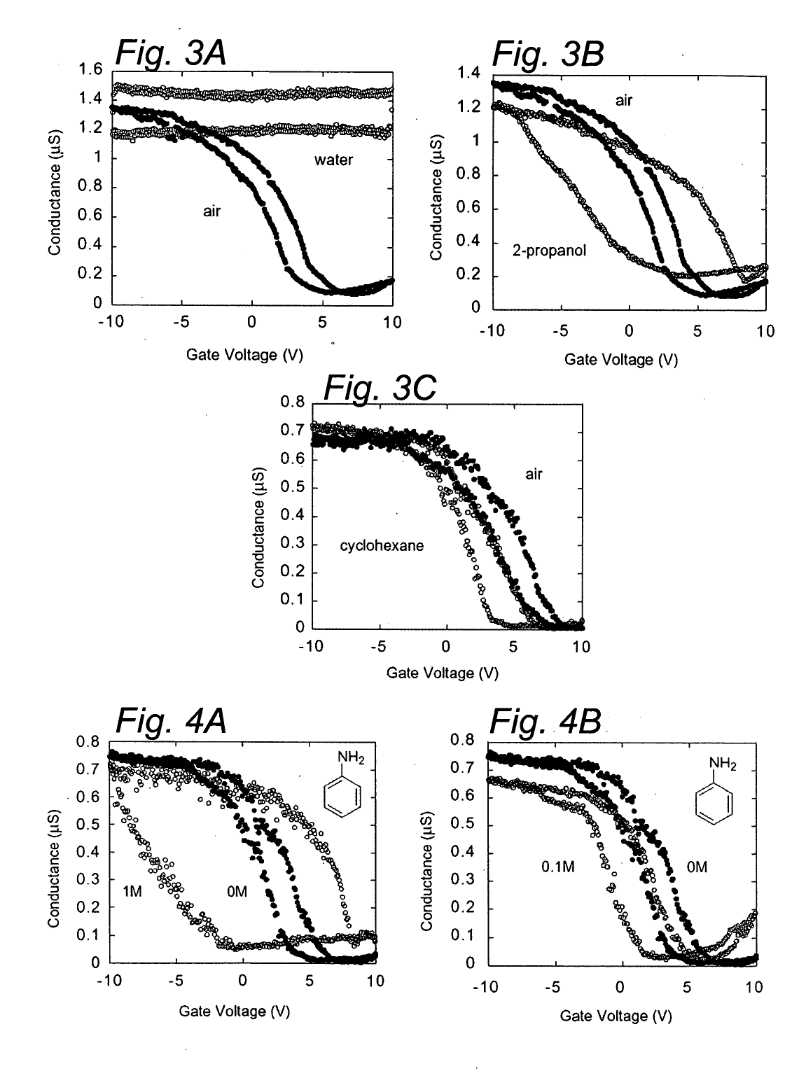

FIGS. 3A-C show comparisons of the performance characteristics of an NTFET device as it operates in air or in the presence of a solvent (water, 2-propanol, or cyclohexane). The conductance—gate voltage relationship (l_{sd}-V_{g}) is shown in plots of conductance (μS) as a function of gate voltage (V_{g}). In all cases, performance data in air are represented by dark circles, and performance in the respective liquid is shown by open circles. In FIG. 3A, the performance in water and air are compared. In FIG. 3B, the performance in 2-propanol and air are compared. In FIG. 3C, the performance in cyclohexane and air are compared. A typical transconductance observed in air is shown in FIG. 3A (dark data points). In air, the devices display p-type behavior, as known to be related to the role of atmospheric oxygen on the device, and they also exhibit a small hysteresis which is postulated to be associated with a hydration layer.

Water and common organic solvents, such as N, N-dimethylformamide (DMF), isopropanol, acetone, and cyclohexane were also applied to NTFET devices. The conductivity of the liquids is found to be an important determinant of device performance. In air and in low conductive liquids such as cyclohexane, the device conductance is dominated by the nanotube channel, consequently the measured NTFET characteristics change relatively little compared to their performance in air, as shown in FIG. 3B. A small shift (e.g., about 2V) to the more negative gate voltage value, i.e., decreasing of p-type character, with the same hysteresis value of approximately 2V (the difference between the current for increasing and decreasing gate voltage, measured at ½ lₘₐₓ, half the maximum current, observed at V_{g} equal to about −10V) can be interpreted as a result of a partial removal of oxygen molecules from the nanotube.

With increasing the conductivity of the liquids, three effects become more apparent. First, the screening of the gate voltage leads to an effectively screened gate voltage, similar to the operation of the device coated with a conducting metal layer such as palladium. Second, the liquid provides an additional conduction channel between the source and gate leading to an increased source-drain current. Third, mobile ions associated with the conducting liquid lead to a significant hysteresis.

The effects of monosubstituted benzenes, such as aniline, phenol, anisole, toluene, chlorobenzene, and nitrobenzene on device performance characteristics have been examined. These various solute compounds have a common geometry with respect to their non-covalent binding to carbon nanotubes, but their substituents provide different inductive and resonance effects upon the binding to nanotube, and their electron donating or withdrawing properties are well established. Aromatic compounds are known to interact strongly with side-walls of carbon nanotubes through effective π-π stacking interactions that form with the graphitic sidewalls of the nanotubes. Such noncovalent exohedral functionalization of nanotubes with aromatic compounds has been documented for their aggregation with a pyrene derivative, for their solubilization in aromatic solvents such as 1,2-dichlorobenzene, and in polymer solutions, when polymers with aromatic backbones were used.

The chip with NTFET was exposed to the solutions in the following order: chlorobenzene, anisole, naphthalene, phenol, nitrobenzene and finally aniline; the results are summarized in Table 1. After each measurement, taken at the two different concentrations of 0.1M and 1M, the chip was rinsed with cyclohexane and chloroform, and blown dry with N₂. The measured baseline characteristics in air were the same after each measurement, except for the case of aniline. After exposure to aniline, the device apparently cannot be washed clean with these solvents, thus indicating irreversible adsorption of the compound on carbon nanotubes. Pronounced noncovalent interactions of nanotubes with aniline and amines in general have been reported earlier.

TABLE 1
Hysteresis Values Measured for Various
Analyte Solutions

| | Hammett | | Hysteresis | Hysteresis |
|---|---|---|---|---|
| | Value | Molarity | Shift | Magnitude |
| Analyte (Moiety) | (σ p) | Tested | (ΔVg) | (δV_{g}) |
| Aniline (NH₂) | −0.66 | 0.1 M | −2.5 | 4 |
| | | 1.0 M | −2.75 | 14 |
| Phenol (OH) | −0.37 | 0.1 M | −1.5 | 11 |
| Anisole (OCH₃) | −0.27 | 0.1 M | −1.5 | 2 |
| | | 1.0 M | −2.0 | 2 |
| Chlorobenzene (Cl) | −0.23 | 0.1 M | −0.5 | 2 |
| | | 1.0 M | −1.0 | 2 |
| Nitrobenzene (NO₂) | '10.78 | 0.1 M | +0.5 | 2 |
| | | 1.0 M | +2.5 | 7 |

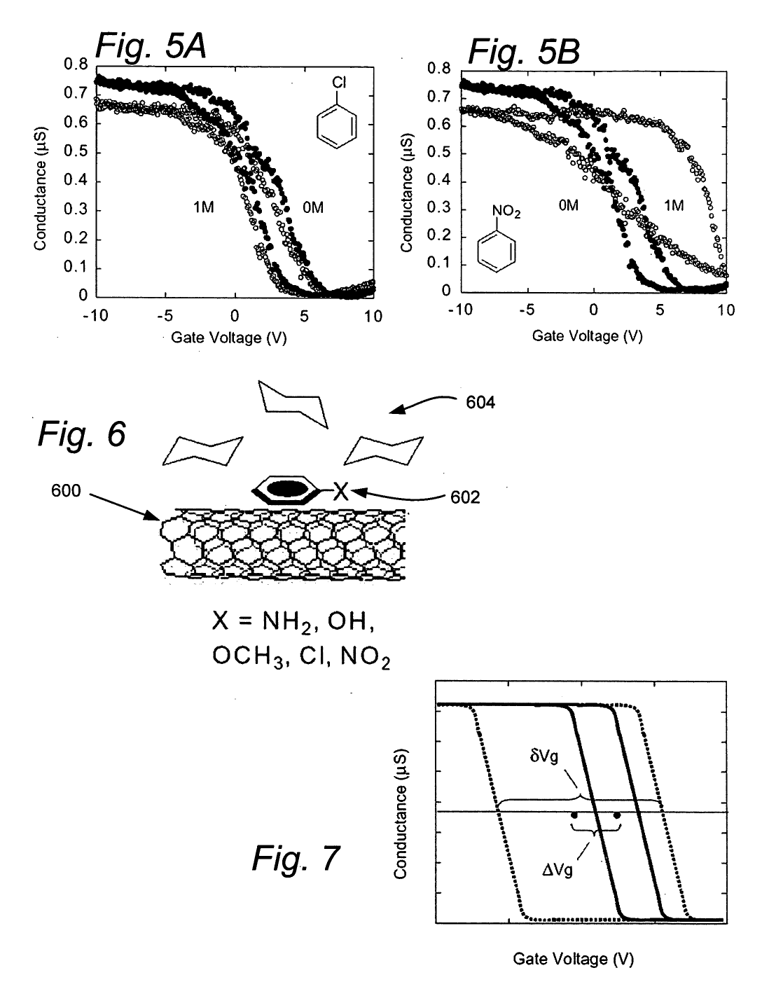

FIGS. 4A-B and 5A-B show the change of device characteristic of the NTFET device with exposure to cyclohexane solutions of representative aromatic hydrocarbons, aniline, chlorobenzene, and nitrobenzene. In all cases, device performance in the presence of the background liquid cyclohexane is represented by dark circles, and the performance in the presence of the respective analyte aromatic hydrocarbon is shown by open circles. In general, the l_{sd}-V_{g} curve shifts towards more negative gate voltages, and at the same time, the hysteresis increases with respect to device performance in pure cyclohexane. For example, the presence of aniline (0.1M in cyclohexane) causes a shift to the left with an increase in hysteresis, as shown in FIG. 4A. Referring to FIG. 4B, the hysteresis increases for a higher (1 M) aniline concentration with no significant additional shift. Chlorobenzene, on another hand, causes only a small leftward shift with no change in hysteresis, as shown in FIG. 5A. Nitrobenzene (1M in cyclohexane) results in a rightward shift and a large hysteresis, as shown in FIG. 5B.

The change in the device performance characteristic upon exposure to aromatic hydrocarbons can be understood by considering the electronic structure of the molecules involved in charge-transfer and the consequent effect on the device characteristics. In solution, a mono-functional benzene molecule 602 is adsorbed on the carbon nanotube 600 conducting channel in an NTFET device and is surrounded by cyclohexane molecules 604, as diagrammed in FIG. 6, with the aromatic molecule attached to side-walls of the nanotube in plane-to-plane conformation.

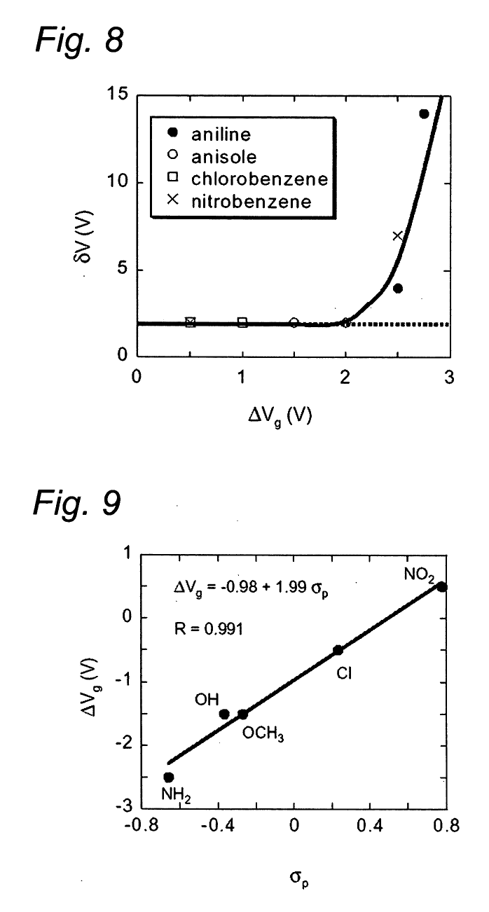

In order to establish a relation between the shift of the l_{sd}-V_{g} characteristics, the two parameters—gate voltage shift (ΔV_{g}) and hysteresis (δV_{g})—were defined as shown in FIG. 7. Hysteresis (δV_{g}) was measured as the difference between gate sweep from +10V to −10V and −10V to +10V at the sweep rate 4 Hz. Gate voltage shift (ΔV_{g}) was defined as a difference between hysteresis midpoints between two l_{sd}-V_{g} curves. FIG. 8 summarizes the correspondence of hysteresis with ΔV_{g}. The relation between the shift and hysteresis can be understood as follows: The shift is the result of charge transfer between the nanotube and the hydrocarbon solutes, leading to excess charges on the tube and opposite charges on the hydrocarbon molecules. Excess charges on the NT lead to a shift of the l_{sd}-V_{g} characteristics, with the partially charged molecules surrounding the NT resulting in a hysteresis. As within the framework of simple models the shift is proportional to the charges on the NT created by charge transfer and the hysteresis depending on both the number of charges surrounding the NT and their mobility, not a strictly linear relation, but a broad correlation is expected, and found.

In accordance with the configuration schematically depicted in FIG. 6, it is appropriate to estimate the charge transfer between the monosubstituted benzenes and the nanotube from their empirical Hammett σ constants, widely used for studying the rates and equilibria of organic reactions. This parameter is related to electron donating or electron withdrawing character of substituents on the benzene ring. Thus the charge-transfer in the complex between monosubstituted benzenes and carbon nanotubes, as well as the measured device characteristics, can be correlated to electronic properties of the substituents (Hammett constants).

In order to establish the correlation between the device performance and Hammett constants, the gate voltage shifts (ΔV_{g}) were measured on the same device at the same concentration in cyclohexane (0.1M). A clear, approximately linear relation is found between the shift and the Hammett values as shown on FIG. 8. The gate voltage shifts towards a more negative values, indicating that the analyte is an electron donor, with increasing positive σₚ values (22). The slope (σ value) is positive +1.99, and a shift of −0.98 volt is expected for benzene (X=H). From FIG. 9, zero shift (and correspondingly no charge-transfer between aromatic hydrocarbon and nanotube) is expected for benzene compounds with electron withdrawing groups (σₚ=0.49). This is reasonable due the presence of adsorbed electron withdrawing species (atmospheric oxygen) on the device at ambient conditions.

The utilization of NTFET devices as sensors in a wet chemistry environment has been shown with low-conducting solvents. Analytes dissolved in a low-conducting solvent, such as cyclohexane, have a pronounced effect on the device characteristics, leading to a shift of the device characteristic (l_{sd} VS. V_{g}). This shift is related to the charge donating or charge withdrawing properties of the analytes, establishing a relation between charge transfer and charge rearrangement as achieved by applied (gate) voltages. An increase of the hysteresis is also observed, this increase related to the charge transfer detected, a relation that follows from established models of the devices. These experiments demonstrate that such devices can be used in the wet chemistry environment, and information on charge transfer can be extracted. Similar results are expected with other liquids having conductivity similar to or lower than cyclohexane. Liquids with somewhat higher conductivity than cyclohexane may also be useful. However, highly conductive liquids, for example, water, are not suitable for use in a measurement method for sensing dissolved analyte as disclosed herein, because the conductivity of the solvent dominates that of the nanotube channel.

Having thus described a preferred embodiment of analyte detection in liquids with carbon nanotube field effect transmission devices, it should be apparent to those skilled in the art that certain advantages of the within system have been achieved. It should also be appreciated that various modifications, adaptations, and alternative embodiments thereof may be made within the scope and spirit of the present invention. For example, analyte detection in cyclohexane has been illustrated, but it should be apparent that the inventive concepts described above would be equally applicable to solvents with non- or low-conductive properties similar to cyclohexane. The invention is further defined by the following claims.

1. A sensing device comprising:
a substrate;
at least one nanotube disposed on the substrate;
at least one electrical contact, the contact being in electrical communication with the at least one nanotube; and
a liquid in contact with the at least one nanotube, wherein the liquid has an electrical conductivity not substantially greater than the electrical conductivity of cyclohexane.

2. The sensing device of claim 1, wherein the liquid comprises cyclohexane.

3. The sensing device of claim 1, wherein the at least one nanotube spans between two electrical contacts.

4. The sensing device of claim 1, wherein the at least one electrical contact comprises a titanium material.

5. The sensing device of claim 2, wherein the substrate comprises a silicon material configure to provide an electrical gate.

6. A method for sensing an analyte dissolved in a liquid, the method comprising:
wetting a NTFE device with a liquid, the device comprising at least one nanotube in electrical contact with a source electrode and a drain electrode and disposed over an electrical gate; and
measuring an electrical property of the NTFE device while wetted with the liquid.

7. The method of claim 6, wherein the wetting step further comprises wetting the NTFE device with a solvent having a conductivity similar to cyclohexane.

8. The method of claim 6, wherein the wetting step further comprises wetting the NTFE device with cyclohexane.

9. The method of claim 6, wherein the wetting step further comprises wetting the NTFE device with cyclohexane in which an analyte is dissolved.

10. The method of claim 6, wherein the wetting step further comprises streaming the liquid over the NTFE device.

11. The method of claim 6, further comprising determining information relating to an analyte in the liquid using information from the measuring step.

12. The method of claim 6, further comprising determining a species of analyte in the liquid using information from the measuring step.

13. The method of claim 6, further comprising determining a concentration of analyte in the liquid using information from the measuring step.

14. The method of claim 6, wherein the measuring step further comprises determining a relationship between a gate voltage and a conductance of the NTFE device.

15. The method of claim 6, further comprising determining a gate voltage shift.

16. The method of claim 6, further comprising determining a hysteresis.

17. The method of claim 6, further comprising processing a measured shift in a threshold gate voltage/conductivity values and a Hammett sigma value to identify an analyte species.

18. The method of claim 6, further comprising processing a measured shift in a threshold gate voltage/conductivity values to determine an analyte concentration in the liquid.

19. The method of claim 6, further comprising processing a gate voltage shift and a hysteresis to determine information relating to an analyte in the liquid.
